(19) United States
(12) Patent Application Publication
(10) Pub. No.: US 2026/0200336 A1
(43) Pub. Date: Jul. 16, 2026

(54) CONTROL DEVICE FOR AN ELECTRIC MACHINE, AND ASSOCIATED METHOD, ELECTRIC MACHINE AND MOTOR VEHICLE

(71) Applicant: AMPERE S.A.S., Boulogne Billancourt (FR)

(72) Inventor: Bassel ASSAAD, Guyancourt Cedex (FR)

(73) Assignee: AMPERE S.A.S., Boulogne Billancourt (FR)

(21) Appl. No.: 19/127,959

(22) PCT Filed: Oct. 20, 2023
(86) PCT No.: PCT/EP2023/079382

§ 371 Date: May 7, 2025

(30) Foreign Application Priority Data
Nov. 10, 2022 (FR) FR2211755

(51) Int. Cl. B60L 15/20; B60W 20/00; H02P 6/08; H02P 29/60

(52) U.S. Cl. CPC B60L 15/20; B60W 20/00; H02P 6/08; H02P 29/60; B60L 2240/12; B60L 2240/421; B60L 2240/423; B60L 2240/425; B60L 2240/642; B60W 2510/081; B60W 2510/083; B60W 2510/087; B60W 2520/10; B60W 2552/15; B60W 2710/186

(57) ABSTRACT

A control device is for an electric machine for driving a motor vehicle with an electric or hybrid drive system. The control device includes a detection unit to detect immobilisation of the motor vehicle on a slope, a first determination unit to determine a reference duration, a time counter that is triggered by the detection unit upon detecting the immobilisation of the motor vehicle on the slope, a second determination unit to determine a control torque for the electric machine based on a setpoint torque and a comparison between the reference duration and the duration elapsed since the triggering of the time counter, and a controller to control the electric machine based on the control torque.

The present invention relates to the control of rotary electric machines.

The present invention relates more particularly to a control device for controlling an electric machine for the propulsion of an electric or hybrid motor vehicle, to an electric or hybrid motor vehicle comprising such a device and to a method implementing such a device.

An electric or hybrid motor vehicle is equipped with a rotary electric propulsion machine.

The electric machine generates a motor-vehicle propulsion torque from a rotor rotated inside a stator by a magnetic field by stator coils that form the phases of the electric machine and through which a current passes.

In general, the electric machine is of the multi-phase, for example three-phase, type.

When the motor vehicle is being propelled, each phase of the electric machine is supplied with a stator current each current having the same intensity such that the phases are balanced.

Because the current passing through each of the phases is the same, the thermal heating generated by the current passing through each of the phases is the same, which means that only one single temperature probe is needed for measuring the temperature of the phase coils.

However, when the driver of the motor vehicle regulates the torque delivered by the rotary electric machine via a throttle pedal in order to immobilize the motor vehicle on a slope, the stator current may be injected into just one phase or into a plurality of phases, which means that each phase has a current of a different intensity passing through it and which means that the thermal heating generated by the passing of current through each phase is different.

Holding the vehicle on a slope requires a stator current of high intensity, generating a significant amount of heating.

The heat produced by the passing of the high-intensity stator current is not dissipated rapidly enough, which means that significant thermal stresses occur and may lead to a phase overheating.

The overheating of a phase may result in the stator coil insulation being destroyed and in the electric machine overheating.

It is known practice to employ two temperature probes each one positioned between two consecutive phases so as to detect the overheating of a phase and prevent the stator coil insulation from being destroyed and the electric machine from overheating.

However, installing two temperature probes in the electric machine entails creating space to house each temperature probe in the electric machine and entails providing wiring for wiring the probes.

The proposal is therefore to alleviate all or some of the disadvantages associated with the use of temperature probes in an electric machine.

In light of the foregoing, one subject of the invention is a method for controlling an electric machine for the propulsion of an electric or hybrid motor vehicle.

The method comprises:
a) detecting that the motor vehicle has been immobilized on a slope,
b) determining a reference duration on the basis of a temperature of a cooling fluid of the electric machine and of a torque applied to a rotor shaft of the electric machine for as long as the motor vehicle is immobilized on a slope,
c) starting a timer upon detection that the motor vehicle has been immobilized on a slope,
d) determining a command torque for commanding the electric machine on the basis of a setpoint torque and of a comparison between the reference duration and the time elapsed since the starting of the timer for as long as the motor vehicle is immobilized on a slope, and
e) commanding the electric machine on the basis of the command torque.

As a preference, the command torque for commanding the electric machine is equal to the setpoint torque when the motor vehicle is not immobilized on a slope or for as long as the time elapsed since the starting of the timer is less than the reference duration.

Advantageously, detecting that the motor vehicle has been immobilized on a slope comprises comparing the torque applied to the rotor shaft of the electric machine against a first predetermined threshold and comparing the speed of the motor vehicle against a second predetermined threshold, the motor vehicle being immobilized on a slope when the torque is above the first predetermined threshold and the speed is below the second predetermined threshold.

As a preference, step a) further comprises initializing a variable representative of the number of repeats of steps b) to d), the variable being set to a predetermined initialization value, and determining a command torque for commanding the electric machine comprises, when the time elapsed since the starting of the timer is greater than or equal to the reference duration:
comparing the command torque against a predetermined detection torque,
determining a first intermediate torque that is equal to the predetermined detection torque when the command torque is below the predetermined detection torque or is equal to the command torque reduced by a first correction torque when the command torque is above the predetermined detection torque,
a first updating of the command torque so that the command torque is equal to the first intermediate torque,
comparing the speed of the motor vehicle against the second predetermined threshold when the electric machine is being commanded on the basis of the command torque equal to the first intermediate torque, and
if the speed of the motor vehicle is above the second predetermined threshold, the method further comprises:
determining a second intermediate torque if the speed of the motor vehicle is above the second predetermined threshold equal to the command torque increased by a second correction torque,
a second updating of the command torque so that the command torque is equal to the second intermediate torque,
if the variable is equal to the initialization value, determining a number of repeats of steps b) to e) on the basis of the temperature of the cooling fluid and of the time elapsed since the starting of the timer,
comparing the value of the variable against the number of repeats, and
if the value of the variable is below the number of repeats, incrementing the value of the variable and repeating steps b) to e).

Advantageously, if the value of the variable is above the number of repeats, the method further comprises activating the parking brakes of the motor vehicle.

As a preference, if the speed of the motor vehicle is below the second predetermined threshold and the torque applied to the rotor shaft of the electric machine is above the first predetermined threshold, the command torque remains unchanged.

A further subject of the invention is a control device for controlling an electric machine for the propulsion of an electric or hybrid motor vehicle.

The device comprises:
detection means configured for detecting that the motor vehicle has been immobilized on a slope,
first determination means configured for determining a reference duration on the basis of a temperature of a cooling fluid of the electric machine and of a torque applied to a rotor shaft of the electric machine for as long as the motor vehicle is immobilized on a slope,
a timer, the detection means being further configured for starting the timer upon detection that the motor vehicle has been immobilized on the slope,
second determination means configured for determining a command torque for commanding the electric machine on the basis of a setpoint torque and of a comparison between the reference duration and the time elapsed since the starting of the timer for as long as the motor vehicle is immobilized on a slope, and
command means configured for commanding the electric machine on the basis of the command torque.

Advantageously the first determination means comprise a predetermined table linking at least a reference duration with a value of the temperature of the cooling fluid and with a value of the torque applied to the rotor shaft of the electric machine.

A further subject of the invention is a hybrid or electric motor vehicle comprising an electric propulsion machine and a control device as defined hereinabove.

Other aims, features and advantages of the invention will become apparent on reading the following description, which is given merely by way of non-limiting example, and with reference to the appended drawings, in which:

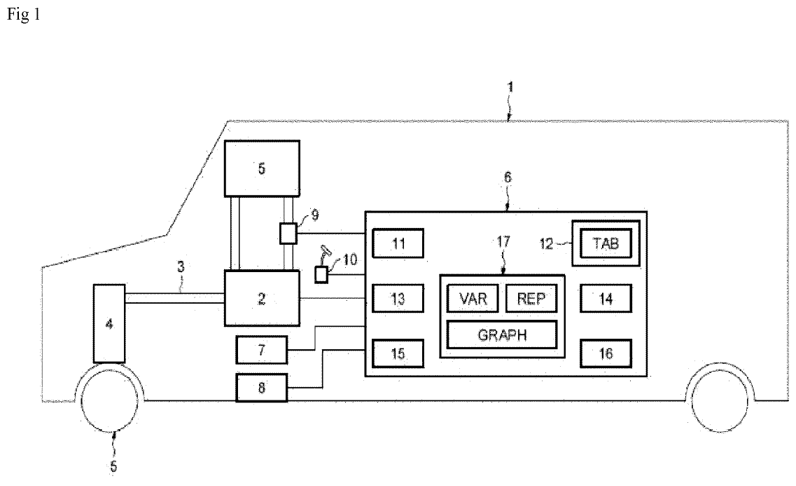

FIG. 1 schematically illustrates one example of a motor vehicle according to the invention;

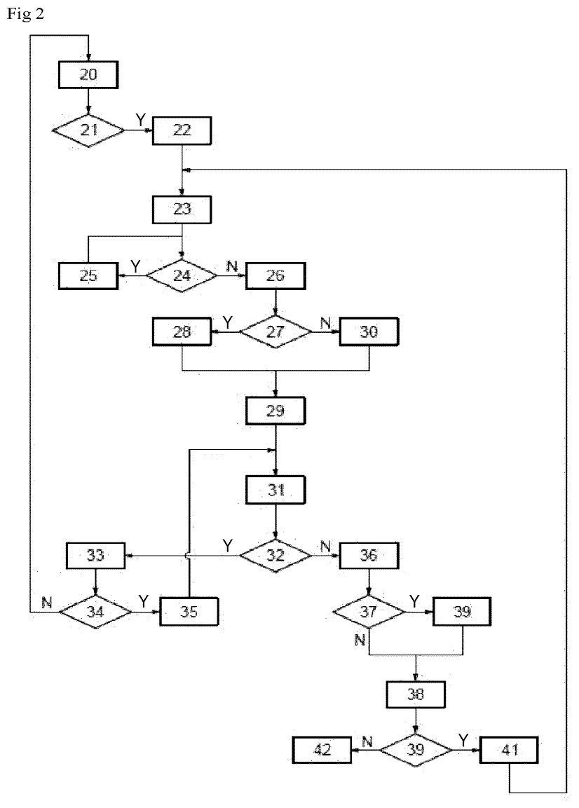

FIG. 2 illustrates one exemplary way of implementing a control device according to the invention; and

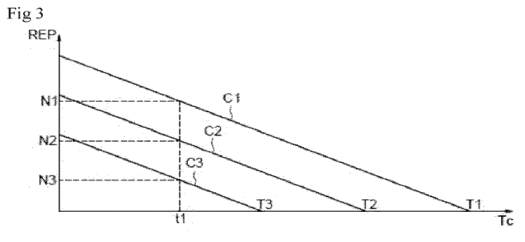

FIG. 3 illustrates one example of a graph linking a number of repeats to temperatures and to durations according to the invention.

FIG. 1 illustrates an electric motor vehicle 1 comprising an electric propulsion machine 2 comprising a rotor shaft 3, a transmission box 4 connected to the wheels 5 of the motor vehicle 1 and driven by the electric machine 2, and a cooling system 5 for cooling the electric machine 2.

As a variant, the motor vehicle 1 is a hybrid motor vehicle comprising the electric machine 2.

The cooling system 5 injects a cooling fluid into the electric machine 2 and collects the cooling fluid that has been warmed by the heat generated by the electric machine 2 so as to cool the electric machine 2.

The fluid comprises for example oil.

The motor vehicle 1 further comprises a control device 6 for controlling the electric machine 2, a torque-estimating device 7, a speed sensor 8 measuring the speed of the motor vehicle 1, a temperature sensor 9 measuring the temperature of the cooling fluid, and a throttle pedal 10 delivering a setpoint torque for the electric machine 2.

The torque-estimating device 7 estimates the torque applied to the rotor shaft 3 on the basis of currents injected into the electric machine 2.

The torque-estimating device 7, the speed sensor 8, the temperature sensor 9 and the throttle pedal 10 are connected to the control device 6.

The control device 6 delivers a command signal to the electric machine 2 this signal being indicative of a command torque, and the throttle pedal 10 delivers a setpoint signal to the control device 6, this signal being indicative of a setpoint torque.

The control device 6 comprises detection means 11, first determination means 12, a timer 13, second determination means 14, and command means 15.

The control device 6 further comprises implementation means for implementing the detection means 11, the first determination means 12, the timer 13, the second determination means 14 and the command means 15.

The implementation means comprise for example a processing unit 16 implementing the detection means 11, the first determination means 12, the timer 13, the second determination means 14 and the command means 15.

Reference is made to FIG. 2 which illustrates one exemplary way of implementing the control device 6.

The command torque for commanding the electric machine 2 is determined by the second determination means 14 on the basis of the setpoint torque, and of a comparison between a reference duration and the time elapsed since the starting of the timer for as long as the motor vehicle 1 is immobilized on a slope, as explained in what follows.

It is assumed that the command signal delivered by the command means 15 is identical to the setpoint signal.

During a step 20, the detection means 11 detect whether the motor vehicle 1 has been immobilized on a slope.

The detection means 11 compare the torque applied to the rotor shaft 3 of the electric machine 2, as delivered by the torque-estimating device 7, against a first predetermined threshold, and compare the speed of the motor vehicle 1, as delivered by the speed sensor 8, against a second predetermined threshold.

The first predetermined threshold is for example equal to 150 Nm and the second predetermined threshold is for example equal to 30 revolutions per minute.

The values of the first and second thresholds are dependent on the type of vehicle 1.

If the torque applied to the rotor shaft 3 is above the first predetermined threshold and the speed of the motor vehicle 1 is below the second predetermined threshold, the motor vehicle 1 is considered as being immobilized on the slope (step 21), and the method continues at step 22.

If not, the motor vehicle 1 is not considered as being immobilized on the slope and the command means 15 deliver the command signal identical to the setpoint signal.

During step 22, a variable VAR stored in a memory 17 of the device 6 is set to an initialization value that is predetermined by the processing unit 16.

The value of the variable VAR is for example set to zero.

Further, the detection means 11 start the timer 13.

During a 23, the first determination means 12 determine a reference duration on the basis of the temperature of the cooling fluid as detected by the temperature sensor 9, and on the basis of the torque applied to the rotor shaft 3, as delivered by the torque-estimating device 7.

The first determination means 12 comprise a predetermined table TAB linking reference durations with values of the temperature of the cooling fluid and with values of the torque applied to the rotor shaft of the electric machine 2.

The table TAB is for example determined empirically by testing.

As long as the timer 13 has not reached the reference duration (step 24), the command means 15 deliver the command signal identical to the setpoint signal (step 25).

When the time elapsed since the starting of the timer 13 is greater than or equal to the reference duration (step 24), the second determination means 14 compare the value of the command torque against the value of a predetermined detection torque (step 26) and determine a first intermediate torque.

If the value of the command torque is below the value of the predetermined detection torque (step 27), then during a step 28, the second determination means 14 update the value of the first intermediate torque to make it equal to the value of the detection torque and the method then continues at a step 29.

If the value of the command torque is above the value of the predetermined detection torque (step 27), then during a step 30, the second determination means 14 determine the value of the first intermediate torque equal to the value of the command torque reduced by the value of a first correction torque.

The correction torque is for example equal to a torque-shortfall factor expressed in newtons per second, multiplied by a duration that is dependent on the type of vehicle 1 and for example equal to −50 Nm/s.

The shortfall factor is determined empirically by conducting various tests on the motor vehicle 1 on slopes of different gradients and with different masses of motor vehicle 1.

The method continues at a step 29.

During step 29, the second determination means 14 update the value of the command torque to make it equal to the value of the first intermediate torque, and the command means 15 deliver the command signal representative of the updated command torque.

During a step 31, the second determination means 14 compare the speed of the motor vehicle 1, as delivered by the speed sensor 8, against the second predetermined threshold.

If the speed of the motor vehicle 1 is below the second predetermined threshold (step 32), then during a step 33, the second determination means 14 compare the value of the torque applied to the rotor shaft 3, as delivered by the torque-estimating device 7, against the first predetermined threshold.

If the value of the torque applied to the rotor shaft 3 is below the first predetermined threshold (step 34), the motor vehicle 1 is considered as no longer being immobilized on the slope.

The method continues at step 20.

If the value of the torque applied to the rotor shaft 3 is above the first predetermined threshold (step 34), then during step 35, the command torque is maintained so that the command signal delivered by the command means 15 remains unchanged, and the method continues at step 31.

If the speed of the motor vehicle 1 is above the second predetermined threshold (step 32), then the motor vehicle 1 is moving.

The value of the command torque is not high enough to immobilize the motor vehicle 1 on the slope, and the method continues at a step 36.

During step 36, the second determination means 14 determine the value of a second intermediate torque equal to the value of the command torque increased by a second correction torque, and update the value of the command torque to make it equal to the value of the second intermediate torque.

The command means 15 deliver the command signal representative of the updated command torque.

If the value of the variable is different than the initialization value (step 37), the method continues at step 38.

If the value of the variable is equal to the initialization value (step 37), then during a step 39, the second determination means 14 determine the value of a variable REP on the basis of the temperature of the cooling fluid, as delivered by the temperature sensor 9, and of the time Tc elapsed since the starting of the timer 13.

The second determination means 14 determine for example the value of the variable REP from a graph GRAPH comprising curves linking the value of the variable REP and the time Tc, each curve corresponding to a different cooling-fluid temperature.

The variable REP and the graph GRAPH are for example stored in the memory 17.

The method then continues at step 38.

FIG. 3 illustrates an example of the graph GRAPH comprising three curves C1, C2, C3 linking the value of the variable REP and the time Tc.

A first curve C1 corresponds to a temperature T1 of the cooling fluid, a second curve C2 corresponds to a temperature T2 of the cooling fluid, and the third curve C3 corresponds to a temperature T3 of the cooling fluid, the temperatures T1, T2, T3 being different than one another.

For example, for a time duration Tc equal to a value t1, the value of the variable REP is equal to N1 if the temperature of the cooling fluid is equal to T1, to N2 if the temperature of the cooling fluid is equal to T2, and to N3 if the temperature of the cooling fluid is equal to T3, the values N1, N2, N3 being different than one another.

The curves C1, C2, C3 are determined for example from numerical simulations and testing involving a plurality of steps of immobilizing the motor vehicle 1 on the slope.

Reference is made again to FIG. 2.

During the step 38, the value of the variable VAR is compared against the value of the variable REP.

If the value of the variable VAR is below the value of the variable REP (step 40), then during a step 41, the value of the variable VAR is incremented and the method continues at step 23.

If the value of the variable VAR is above the value of the variable REP (step 40), then during a step 42, the command device 6 delivers a second signal to means for commanding the parking brakes of the motor vehicle 1 (these are not depicted) to activate the parking brakes of the motor vehicle 1.

Furthermore, a human-machine interface (not depicted) of the motor vehicle 1 alerts the driver of the motor vehicle 1 to the activation of the parking brakes.

The human-machine interface comprises for example an indicator light.

The variable REP determined in step 39 is representative of the maximum number of repeats of steps 23 to 41 so as to prevent the electric machine 2 from overheating.

The command device 6 allows the temperature of the electric machine 2 to be controlled in such a way as to avoid overheating of the electric machine 2 when the motor vehicle 1 is immobilized on a slope, without adding a temperature probe in the electric machine 2.

As a variant, the value of the torque applied to the rotor shaft 3 may be determined by some means other than the torque-estimating device, for example using a model of the electric machine 2.

As a variant, the value of the speed of the motor vehicle 1 may be determined by some means other than the speed sensor 8, for example on the basis of information passing along a bus of the motor vehicle 1.

As a variant, the value of the temperature of the cooling fluid may be determined by some means other than the temperature sensor 9, for example using a model of the electric machine 2.

As a variant, the value of the setpoint torque may be determined by some means other than the throttle pedal 10, for example on the basis of information passing along a bus of the motor vehicle 1.

1-9. (canceled)

10. A method for controlling an electric machine for a propulsion of an electric or hybrid motor vehicle, the method comprising:
a) detecting that the motor vehicle has been immobilized on a slope;
b) determining a reference duration based on a temperature of a cooling fluid of the electric machine and of a torque applied to a rotor shaft of the electric machine for as long as the motor vehicle is immobilized on the slope;
c) starting a timer upon detection that the motor vehicle has been immobilized on the slope;
d) determining a command torque for commanding the electric machine based on a setpoint torque and of a comparison between the reference duration and the time elapsed since the starting of the timer for as long as the motor vehicle is immobilized on the slope; and
e) commanding the electric machine based on the command torque.

11. The method as claimed in claim 10, wherein the command torque for commanding the electric machine is equal to the setpoint torque when the motor vehicle is not immobilized on the slope or for as long as the time elapsed since the starting of the timer is less than the reference duration.

12. The method as claimed in claim 10, wherein the detecting that the motor vehicle has been immobilized on the slope comprises comparing the torque applied to the rotor shaft of the electric machine against a first predetermined threshold and comparing a speed of the motor vehicle against a second predetermined threshold, the motor vehicle being immobilized on the slope when the torque is above the first predetermined threshold and the speed is below the second predetermined threshold.

13. The method as claimed in claim 12, wherein step a) further comprises initializing a variable representative of a number of repeats of steps b) to d), the variable being set to a predetermined initialization value, and wherein the determining the command torque for commanding the electric machine when the time elapsed since the starting of the timer is greater than or equal to the reference duration comprises:
comparing the command torque against a predetermined detection torque,
determining a first intermediate torque that is equal to the predetermined detection torque when the command torque is below the predetermined detection torque or is equal to the command torque reduced by a first correction torque when the command torque is above the predetermined detection torque,
a first updating of the command torque so that the command torque is equal to the first intermediate torque,
comparing the speed of the motor vehicle against the second predetermined threshold when the electric machine is being commanded based on the command torque equal to the first intermediate torque, and
when the speed of the motor vehicle is above the second predetermined threshold, the method further comprises:
determining a second intermediate torque when the speed of the motor vehicle is above the second predetermined threshold equal to the command torque increased by a second correction torque,
a second updating of the command torque so that the command torque is equal to the second intermediate torque,
when the variable is equal to the initialization value, determining a number of repeats of steps b) to e) based on the temperature of the cooling fluid and of the time elapsed since the starting of the timer,
comparing the value of the variable against the number of repeats, and
when the value of the variable is below the number of repeats, incrementing the value of the variable and repeating steps b) to e).

14. The method as claimed in claim 13, wherein when the value of the variable is above the number of repeats, the method further comprises activating parking brakes of the motor vehicle.

15. The method as claimed in claim 13, wherein when the speed of the motor vehicle is below the second predetermined threshold and the torque applied to the rotor shaft of the electric machine is above the first predetermined threshold, the command torque remains unchanged.

16. A control device for controlling an electric machine for a propulsion of an electric or hybrid motor vehicle, the device comprising:
detection means configured for detecting that the motor vehicle has been immobilized on a slope;
first determination means configured for determining a reference duration based on a temperature of a cooling fluid of the electric machine and a torque applied to a rotor shaft of the electric machine for as long as the motor vehicle is immobilized on the slope;
a timer, the detection means being further configured for starting the timer upon detection that the motor vehicle has been immobilized on the slope;
second determination means configured for determining a command torque for commanding the electric machine based on a setpoint torque and a comparison between the reference duration and the time elapsed since the starting of the timer for as long as the motor vehicle is immobilized on the slope; and
command means configured for commanding the electric machine based on the command torque.

17. The control device as claimed in claim 16, wherein the first determination means comprise a predetermined table linking at least a reference duration with a value of the temperature of the cooling fluid and with a value of the torque applied to the rotor shaft of the electric machine.

18. An electric or hybrid motor vehicle, comprising:
the electric propulsion machine; and
the control device as claimed in claim 16.
